(19) United States
(12) Patent Application Publication
(10) Pub. No.: US 2011/0284116 A1
(43) Pub. Date: Nov. 24, 2011

(54) HIGH-TEMPERATURE FLEXIBLE COMPOSITE HOSE

(75) Inventors: Kevin Donnelly, Uxbridge (CA); Melinda Donnelly, Sunderland (CA)

(73) Assignee: Novaflex Hose Inc., Haw River, NC (US)

(21) Appl. No.: 13/112,177

(22) Filed: May 20, 2011

Related U.S. Application Data
(60) Provisional application No. 61/346,658, filed on May 20, 2010.

(51) Int. Cl. F16L 11/00; B29C 53/58

(52) U.S. Cl. 138/129; 156/143

(57) ABSTRACT

A high-temperature composite hose (100) allows for the carrying out of high temperature air, gases and liquids in a range of 600 to 2000° F. The hose remains flexible at such elevated temperatures and may be used in situations where solid or flexible metal hose was previously used. The hose construction preferably includes a spirally wound inner wire element (10) over which is applied multiple layers (21, 23, 17) preferably beginning with a layer of heat resistant textile or fabric (21) and ending with a cover layer (17) which serves to provide abrasion and other resistance to the composite hose. A 2nd outer wire element (16) is preferably applied which, in connection with the inner wire element 10, serves to sandwich or compress and hold the heat resistant and other hose layers (21, 23, 17) together.

### CROSS-REFERENCE TO RELATED APPLICATIONS

This application claims priority from U.S. Provisional Patent Application No. 61/346,658 titled High-Temperature Flexible Composite Hose filed on May 20, 2010 and incorporated fully herein by reference.

### TECHNICAL FIELD

The present invention relates to composite hoses and more particularly, relates to flexible, composite hoses able to withstand high temperatures for use in various heat resistant high-temperature applications.

### BACKGROUND INFORMATION

Various applications currently make use of flexible, composite hoses. For example, carrying and dispensing of various fluids, gas and the like utilizes such composite hoses. Presently, all composite hose is made in much the same manner, with variations in the number of films and fabrics to provide barrier protection against fluids and products being carried such as LPG (liquefied petroleum gas). In these prior art composite hoses, there is normally a ‘film’ material used as the first liquid barrier that is then followed by multiple plies of films and fabrics oriented on the same and/or opposite bias and as well spirally applied. In some cases a tube film is pulled on to the hose “mandrel” as the first layer versus a spirally wound first layer. However, none of these prior art composite hoses are made to withstand elevated temperatures of between 500° to 2000° F.

When it comes to high-temperature applications, the prior art has made use essentially exclusively of metal hose. Such metal hose is either solid metal hose or metal interlock hose made from spirally wound and interlocking metal segments, such as aluminum or stainless steel. Such metal interlock hose and is spirally wound metal with a seam that allows it to be bent somewhat but not flex continuously. Solid metal hose although acceptable, has limitations in that it cannot be utilized in a situation where the hose must be made to conform to other than a straight run or the configuration (bend) that was imparted to the metal hose when it was manufactured. Although the spirally wound and interlocking metal hose can be bent in the field to some degree, the spirally wound interlocking hose does have a limitation on how much it can be bent and the failure rate of the interlocking spirally wound pieces is significant and of concern.

Accordingly what is needed is a composite material hose which can handle high temperatures (in a range of 500 to 2000° F.) and that can be utilized in various high-temperature applications wherein the hose must be bent, turned or curved, all without requiring the hose to be custom formed.

### SUMMARY

The present invention features a composite hose that is designed specifically to handle extreme temperature gases and potentially liquids including, but not limited to hot exhaust including diesel engine exhaust or hot air. The present application utilizes materials and techniques that, in combination, allow this hose to be used where traditional metal hose or hard piping would be used. The selected films and fabrics act as heat shields and insulators against the hot exhaust to be conveyed. Traditional rubber hose and plastic hoses cannot withstand the elevated temperatures of the intended application and metal hose does not allow for the flexibility and constant flexing required.

For exemplary purposes only, the present invention will be explained with regards to two styles of composite hose; each style based on temperature resistance. The first style is resistant to approximately 600° F. and the second to 1200° F. and higher. No other prior art “composite” hose has, to date, been able to be utilized to exhaust hot air in ‘hot air blower’ applications utilized in diesel engines; nor has ‘composite’ hose been used for the exhaust of diesel combustion by product on diesel engines; for diesel engine exhaust stacks as the elbow to replace metal hose; and for diesel engine “intercoolers”. An intercooler is a simply a heat exchanger mounted between the turbo-charger, or super-charger and the inlet side of the engine. Cold air is blown through it to cool down the hot, compressed air inside. Composite hose is manufactured completely different which allows for the free movement or continuous flexing of the hose vs. metal hose that either cannot be bent or does not allow for continuous flexing.

The present invention can be utilized to carry exhaust from a turbocharger and intercooler system on diesel engines (including on highway and off highway engines). Turbocharged engines are found in light, medium and heavy-duty trucks, and bus, agricultural, marine, and automotive, performance automotive and industrial settings including heavy equipment and generators.

Another application for the present invention is for a ‘hot air blower’ hose for bulk transport trucks. That is to convey the hot air from an air pump used in pneumatic pressure loading/unloading systems of dry bulk materials from tank trucks. Dry bulk trailers are used to transport materials such as cement, flash, sand, limestone and other materials used in the construction industry as well as food grade products such as flour, sugar, plastic pellets etc.

Another novel application for the present invention is to replace the metal interlock portion of a diesel engine exhaust stack found on transport trucks. The vertical portion of the stack is manufactured with rigid, smooth metallic pipe. Metal interlock hose is used to make up the “elbow” portion(s) as are rigid metal elbows.

The invention features a high temperature composite hose comprising an inner wire element wound in a spiral fashion and having a predetermined spacing. One or more inner layers are applied over the inner wire element following which a cover layer is applied over the one or more inner layers. Lastly, an outer wire element is applied over the cover layer, wherein the outer wire is applied in a spiral fashion and wherein the outer wire is configured to be placed in between the predetermined spacing of the inner wire element.

The inner wire element may be standard circular wire, flattened wire, or semicircular wire while being constructed from a material selected from the group consisting of steel, aluminum, plastic or composite material. The inner wire element features a profile that includes round, flat, concave or oval. The predetermined spacing of the inner wire element is typically generally between 0 to 2 inches.

In one embodiment, the one or more inner layers are applied in one or more application methods including spirally applied in one direction, spirally applied in opposing directions, longitudinally applied down a length of the hose, or in any combination of these application methods. In the case of an application of two or more layers, an overlap of a second layer over a first layer is provided.

The one or more inner layers may include glass reinforced fabric, glass reinforced textile, ceramic cloth, fabric woven of metals, fabric woven of metal filaments, fabric braided of metal, fabric braided of metal filaments, glass woven textile, ceramic woven textile, glass or ceramic woven textile reinforced with metal or metal filaments, film and metal foils. The one or more inner layers may also include a para-aramid synthetic fiber fabric or textile. The functional temperature resistance to exhaust, gaseous media and air at elevated temperatures of the one or more inner layers ranges from 500° F. to 2000° F.

In another embodiment, the one or more inner layers include at least a first inner layer proximate the inner wire element and a second layer proximate the first inner layer, wherein the second layer is typically selected from para-aramid synthetic fiber or textile, a para-aramid coated textile, a fabric woven or braided of metals or metal filaments, a textile or cloth made of natural fibers, silicone rubber, silicone coated textile, films made of polytetrofluoro ethylene, textiles coated with polytetrofluoro ethylene based material, nylon film, nylon coated textiles, metal foils, fluoro elastomer coated textiles, ethylene propylene diene monomer coated textiles, flame retardant thermoplastic rubber and non-flame retardant thermoplastic rubber.

The cover layer provides one or more properties including UV resistance, ozone resistance, abrasion resistance, scuff resistance, liquid resistance and chemical resistance. The cover layer may be constructed from a material including a plastic film, a thermoplastic film, a composite, a polyimide film, a coated fabric or textile cloth made of natural fibers such as cotton, an uncoated fabric or textile cloth made of natural fibers such as cotton, and a synthetic fiber selected from the group consisting of nylon, polyester and rubber polymer. The cover layer may be applied in a manner including spiral wound in one direction and angle, spiral wound in opposing directions and angles and longitudinally.

The hose may further include one or more carcass layers disposed between the one or more inner layers and the cover layer, wherein the one or more carcass layers are configured to provide material strength both axially and longitudinally and to serve as a filler and an insulator, wherein the one or more carcass layers may be constructed from a material including a plastic film, a thermoplastic film, a polyimide film, a fabric or textile cloth coated or uncoated made of natural fibers such as cotton, and a synthetic fiber selected from the group consisting of nylon, polyester, and rubber polymer. The one or more carcass layers may be applied in a manner including spiral wound in one direction and angle, spiral wound in opposing directions and angles and longitudinally.

One of the inner or cover layers of the hose may include a polyimide film, wherein the polyimide film is configured to serve as both a gas barrier as well as a thermal barrier.

The invention also features a method of forming a high temperature composite hose including the acts or steps of forming an inner wire element wound in a spiral fashion and then applying one or more inner layers of fabric and/or textile over the wound inner wire element, wherein at least a first inner layer adjacent said inner wire element includes a heat resistant material. The method next includes applying a cover layer over the one or more inner layers of fabric and/or textile and then subsequently wrapping an outer wire element over the cover layer, wherein the outer wire is applied in a spiral fashion and wherein the outer wire is configured to be placed in between a spacing of the inner wire element, wherein the outer wire element provides axial and hoop strength as well as compression strength.

### BRIEF DESCRIPTION OF THE DRAWINGS

These and other features and advantages of the present invention will be better understood by reading the following detailed description, taken together with the drawings wherein:

FIG. 1 is a cross-sectional schematic diagram showing one example of a wire cross-sectional profile and wire pitch;

FIG. 2 is a cross-sectional schematic diagram showing another example of a wire cross-sectional profile and wire pitch;

FIG. 3 is a cross-sectional schematic diagram showing yet another example of a wire cross-sectional profile and wire pitch;

FIG. 4 is a cross-sectional schematic diagram showing one example of wire spacing or pitch;

FIG. 5 is a cross-sectional schematic diagram showing another example of wire spacing or pitch;

FIG. 6 is a schematic diagram illustrating a wrapping technique according to one example of the method of making a composite hose according to the present invention;

FIG. 7 is a schematic diagram illustrating another wrapping technique according to yet another example of the method of making a composite hose according to the present invention; and

FIG. 8 is a schematic diagram illustrating yet another cigar wrapping technique according to another example of the method of making a composite hose according to the present invention.

### DETAILED DESCRIPTION OF THE PREFERRED EMBODIMENTS

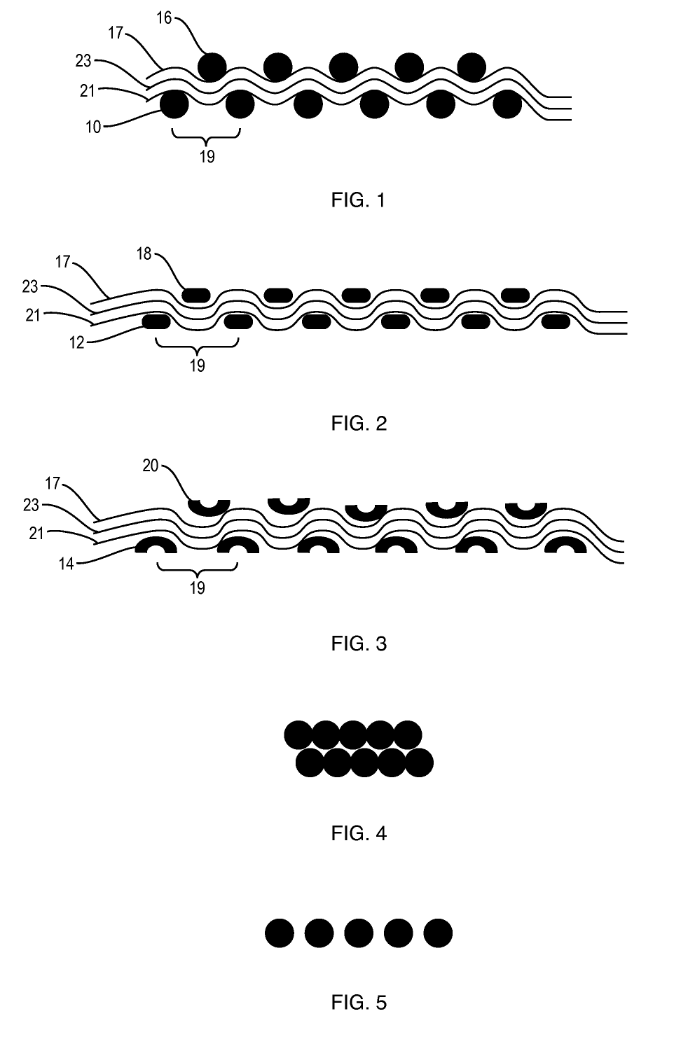

The high temperature composite hose according to the present invention is constructed by first applying an inner metal or non-metal wire or other profile element (10, 12, or 14) along a cylindrical mandrel (rigid pipe) (not shown) in a spiral fashion (such that the wire or profile is ‘spiraled’ onto the mandrel). This provides the inner hoop with axial strength and a certain amount of longitudinal strength. The metal wire may be standard circular wire 10, FIG. 1, or optionally, other shapes of wires including flattened top and bottom portions as shown at 12, FIG. 2 or perhaps even semicircular wires 14, FIG. 3. Any shape or size wire is contemplated by the present invention.

In addition, the wire pitch or spacing (the distance between the each individual wire) may be adjusted as desired between approximately 0 to 2 inches, although other wider ranges are contemplated. As shown in FIG. 4, the wire pitch or spacing is approximately 0 (the wires are touching each other) whereas in FIG. 5, the wires are arranged at a greater pitch or spacing.

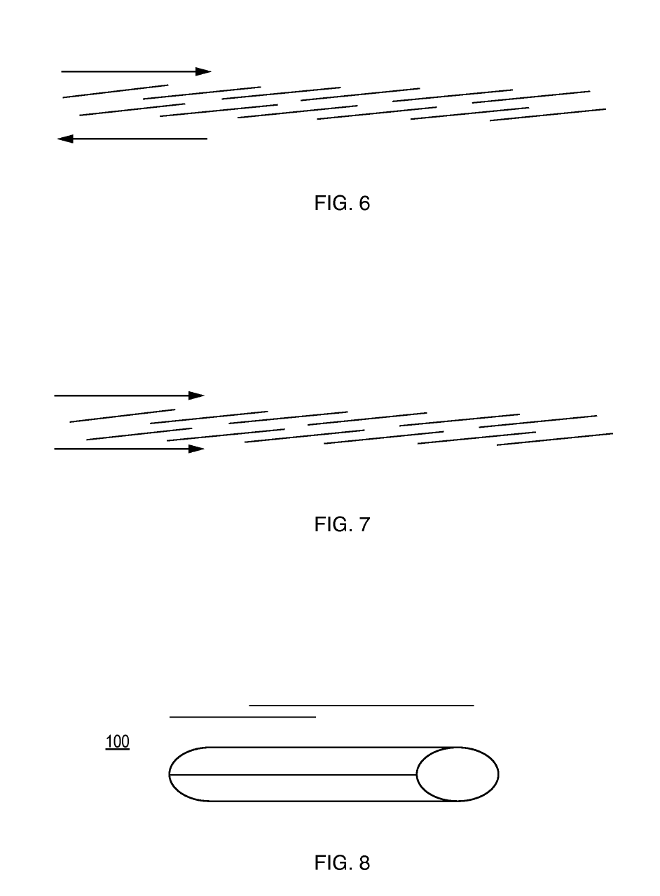

Next, multiple plies or layers of fabrics (coated and/or uncoated) and/or textiles are applied. The various layers or plies of fabrics or textiles may be applied in a spirally wound fashion in either one direction (all layers being applied from one end of the mandrel to the other end) and angle (see FIG. 7) or opposing angles and directions (a first layer is spirally wound from left to right while the 2nd layer is spirally wound from right to left at the same or different angle) (see FIG. 6) with or without an overlap (with third and subsequent layers applied in a similar alternating direction; or applied longitudinally with a longitudinal seam (as in a “cigar wrap”) (see FIG. 8). A cover or exterior layer 17 can then be applied over the other layers and that provides UV, abrasion, scuff, and/or liquid/chemical resistance to protect the interior layers. Finally an outer wire is applied (16, 18 or 20) again in a spiral fashion and is placed in between the wire spacing 19 of the inner wire (10, 12 or 14) placement. This provides additional axial and hoop strength but more importantly, it provides the compression strength to sandwich or contain the multiple inner layers of films and fabrics in place such that it provides a liquid and air tight seal in the hose wall or body. The multiple layers of fabrics and textiles and film that make up the hose wall or “carcass” are typically a maximum of up to 1″ thick in total although the invention contemplates thicker and thinner dimensions. It is envisioned that the composite hose according to the present invention may be made to have a diameter of from ½ to 8 inches or more.

The composite hose of the present invention differs from the prior art in the layers of materials used, the combinations used and their placement such that the composite hose of the present invention maintains the flexibility of traditional composite hose, interlock metal hose, rubber hoses etc. however, the improvement and novel and non-obvious difference being that the presently described high-temperature composite hose utilizes materials and assembly sequences that allow for a functional temperature resistance to hot exhaust of greater than 662 F. The thermal melt temperature of products such as Teflon in the polytetrofluoro Ethylene family (including PFA, FEB, Tefzel) utilized in the prior art is 662° F. and below so that by eliminating those as possible inner plies or layers, the present composite hose can be made to withstand higher temperatures. Such material can be incorporated elsewhere in the layering of the hose.

To achieve this high temperature resistance disclosed and taught by the present invention, the composite hose utilizes a combination of glass reinforced fabrics or textiles, fabrics woven of metals, metal reinforced glass fabrics, metal foils or thin metal sheets of approximately 2 mm thick or less, along with Para-Aramid synthetic fiber fabric/textile such as Kevlar®, Nomex® or other Para-Aramid coated textiles. These layers are used in combination and in an order whereby the glass and metal based materials are in the inner plies while the para-aramid textiles or coated textiles are used behind where they can be insulated from the direct exhaust heat being carried by the composite hose. In the event the metal and glass based materials are not the first layers that the para-aramid textiles (such as Nomex® coated textile, and/or Kevlar® based textile) used as the inner plies to reach a functional temperature of 800° F. or greater the first layers become charred or degraded and act as primarily a sacrificial inner layer.

The composite hose invention involves the use of particular tube and carcass layers in particular combinations and placement to provide a functional temperature resistance to but not limited to exhaust, gaseous media, and air at elevated temperatures from 500 deg. F. to 2000 deg. F. Further, the construction therein provides for maintaining the flexibility of traditional composite hose, interlock metal hose, rubber hoses etc. while at the same time maintaining a Functional Temperature resistance to the media and temperatures as cited above.

The following illustrates an exemplary high-temperature hose construction. The following is for illustrative and discussion purposes only being understood that the present invention is not to be considered restricted or limited to this description.

1^{st} layer 21—Metal or non-metal (steel, aluminum, plastic or composite) wire profile spiraled onto cylindrical mandrel (rigid pipe) in a helical coil fashion. This profile may be either round, flat, concave, oval or other profile in shape. The profile may have an outside dimension of, for example only, 0.025″ to 0.375″ in size and may be spiraled with a spacing of zero to 2″ or more wide between the next spiral (commonly known as “wire pitch”) and wound in either one direction or opposite direction to start position, to be spiraled perpendicular to mandrel or at an angle of 30 degrees or more or less. The inner wire layer may consist of one or more inner wires. Although typically one wire would be used, the present invention contemplates one or more inner wires to fashion the first wire layer and inner wire layers.

2^{nd} layer(s) 23—may be a single layer or multiple (plurality) of layers wherein said tube layers are to be resistant to heat at elevated temperatures starting from proximately 500° F. to 2000° F.

The first tube layer 21 may be:

“A”—Glass reinforced fabric or textile such as E-Glass measuring in weight of 100 oz. per sq. yard or less and measuring in width from ½″ to 78.5″ wide.

Or “B”—Glass or ceramic cloth measuring in weight of 100 oz. per sq. yard or less and measuring in width from ½″ to 78.5″ wide.

Or “C”—Fabric woven or braided of metals or metal Filaments measuring in weight of 100 oz. per sq. yard or less and measuring in width from ½″ to 78.5″ wide.

Or “D”—Glass or ceramic woven textile reinforced with metal or metal filaments measuring in weight of 100 oz. per sq. yard or less and measuring in width from ½″ to 78.5″ wide.

Or “E”—Metal foils of a gauge measuring between one micron and 2 mm and measuring in width from ½″ to 78.5″ wide.

In all variations described above, the material may be either spirally wound as described above with or without a mandrel or wrapped in a “cigar” fashion, all without departing from the spirit of the present invention. The above layer(s) may be applied in a spiral wound (or longitudinal) fashion in either of one direction and angle or opposing directions or angles with an overlap of zero inches to 2″ inches. Alternatively the above inner layer(s) may be applied longitudinally down the length of the mandrel. In addition, various layers may be applied in various methods. For example, one or more layers may be spirally wound while one or more layers may be longitudinally applied with an almost unlimited combination of these 2 methods and other methods possible and considered to be within the scope of the present invention. Moreover, subsequent fabric or other similar material layers may be applied over inner profile wire (see layer 1) in a wrapped fashion with a longitudinal abutting seam or overlapping seam of zero to the circumference of the mandrel diameter with clearance of first layers effectively becoming two layers (plies).

The above described tube layers can be applied singly or in any combination producing a tube layer thickness of a minimum of 0.001″ of the above layers to be formed into a ‘tube’ of claimed hose and provide resistance to heat from a 500 f to 2000 deg. F. Alternatively, the tube layers may be a single layer or multiple layers wherein the tube layers are to be resistant to heat at lower temperatures (between 185 f and 662 F). The tube layers work to prevent heat transfer to the carcass and secondary tube layers, and further act to shield or act as a barrier which when used or applied in combination increase the functional temperature resistance of 500 F and higher.

Alternatively, the inner tube layer(s) may be a single layer or plurality of layers wherein the inner tube layer(s) are typically resistant to heat at lower temperatures starting from 185 F to 662 F. The inner tube layer(s) may work in conjunction to prevent heat transfer to the tube as a whole (tube carcass) and secondary tube layers, further to act as heat shield compensator and barrier which when used or applied in combination increase the functional temperature of tube layer(s) and carcass layers when exposed to elevated temperatures above their respective functional temperature to allow for the functioning of the hose in its intended use, that being for the exhaust of air and gaseous media at 500 deg f. to 2000 deg f.

The second tube layer 23 may be any one of the following described layers/material A through L:

“A”—Para-Aramid synthetic fibers or textiles such as “Kevlar” registered trademark of DuPont Company, “Nomex” registered trademark of DuPont Company, measuring in weight of 100 oz. per sq. yard or less and measuring in width from ½″ to 78.5″ wide.

“B”—Para-Aramid coated textiles measuring in weight of 100 oz. per sq. yard or less and measuring in width from ½″ to 78.5″ wide.

“C”—Fabric woven or braided of metals or metal Filaments measuring in weight of 100 oz. per sq. yard or less and measuring in width from ½″ to 78.5″ wide.

“D”—Textiles or cloth made of natural fibers such as cotton measuring in weight of 100 oz. per sq. yard or less and measuring in width from ½″ to 78.5″ wide.

“E”—Silicone rubber or silicone coated textiles of a gauge measuring 2 mm in thickness or less to one micron and measuring in width from ½″ to 78.5″ wide.

“F”—Films made of polytetrofluoro Ethylene family such as FEP, PTFE, PFA, FEB or Tefzel (registered trademark of DuPont Company) of a gauge measuring 2 mm in thickness or less to one micron and measuring in width from ½″ to 78.5″ wide.

“G”—Textiles coated of polytetrofluoro Ethylene based Material, of a gauge measuring 2 mm in thickness or less to one micron and measuring in width from ½″ to 78.5″ wide.

“H”—Nylon film or nylon coated textiles of a gauge measuring 2 mm in thickness or less to one micron and measuring in width from ½″ to 78.5″ wide.

“I”—Metal foils of a gauge measuring 2 mm in thickness or less to one micron and measuring in width from ½″ to 78.5″ wide.

“J”—Fluoro Elastomer (FKM) such as Viton or Viton coated textiles of a gauge measuring 2 mm in thickness or less to one micron and measuring in width from ½″ to 78.5″ wide. Viton is a registered Trademark of DuPont.

“K”—Ethylene Propylene diene Monomer (EPDM) or (EPDM) coated textiles of a gauge measuring 2 mm in thickness or less to one micron and measuring in width from ½″ to 78.5″ wide.

“L”—Flame retardant or non-flame retardant Thermoplastic rubber (TPRs), such as Thermoplastic ethylene or Thermoplastic Olefins or textiles coated with same, of a gauge measuring 2 mm in thickness or less to one micron and measuring in width from ½″ to 78.5″ wide.

The above mentioned second tube layer(s) 23 may be applied in a spiral wound fashion in either of one direction and angle or opposing directions or angles with an overlap of zero inches to 2″ inches. One or more of the layers may be utilized alone or in combination. Alternatively the above layers may be applied longitudinally down the length of the mandrel over inner profile wire in a wrapped fashion with a longitudinal abutting seam or overlapping seam of zero to the circumference of the mandrel diameter with clearance of first layers effectively becoming two layers (plies). Alternatively, any one or more of the above said layers may be applied in various combinations of these 2 methods.

The above second tube layer(s) 23 may be applied singly or in any combination producing a tube layer thickness of a minimum of 0.001″ of the above layers to be the ‘tube’ of the claimed hose and provide resistance to heat from 185 f to 2000 deg. F.

3^{rd} layer(s)—(carcass layers not shown or numbered in the drawings) may be a single layer or plurality of layers applied over the second tube layer 23 wherein the carcass layers serve as filler and insulator, to provide back up material strength both axially and longitudinally and to allow for inner and outer final profile wire to compress tube and carcass layers between inner and outer profile wires effectively ‘sandwich’ layers to prevent them from moving, unwinding, and unwrapping. Alternatively in a case whereby multiple tube layers provide sufficient back up material thickness for same purpose, this 3^{rd} or Carcass layer(s) can be omitted altogether.

Carcass layers may be comprised of any conventionally known film made of plastic, thermoplastic such as polyvinyl chloride, or composite, or polyimide film, any fabric or textile cloth coated or uncoated made of natural fibers such as cotton or any synthetic fiber such as nylon, polyester, rubber polymer, OR any material described above in connection with the tube layers and typically measuring in width from a minimum of approximately but not limited to ½″ to a maximum of 78.5″ wide and measuring in thickness of 2 mm or less to a micron and in the case of textiles from 100 oz. sq. yd or less.

The above described carcass layers may be applied in a spiral wound fashion in either of one direction and angle or opposing directions or angles with an overlap of zero inches to 2″ inches. Alternatively the above mentioned layers may be applied longitudinally down the length of the mandrel over the inner profile wire (see layer 1) and over the tube layer (see layer 2) in a wrapped fashion with a longitudinal abutting seam or overlapping seam of zero to the circumference of the mandrel diameter with clearance of first layers effectively becoming two layers (plies). In another alternative hose assembly technique, the various ‘films’ or layers can be in tube form already and therefore are not spiraled on or cigar wrapped but ‘pulled’ onto the mandrel like a sock.

The above carcass layers may be applied singly or in any combination producing a carcass layer measuring in combination with the tube layer of a minimum of approximately 1/16″ to a maximum of 1″ thick or more.

The 4^{th} Layer 17, also termed a cover or outer layer, may be a single layer or plurality of layers wherein the cover layer(s) 17 are to act as a protective sheath to provide resistance to ozone, chemical attack, UV resistance, abrasion and scuff resistance, resistance to water or liquid. Alternatively in a case whereby multiple carcass layers provide sufficient back up material and thickness and/or where no external environmental concerns are present, the cover layer can be omitted altogether.

Cover layers 17 may comprise of any conventionally known film made of plastic, thermoplastic such as polyvinyl chloride, or composite or polyimide film; any fabric or textile cloth coated or uncoated made of natural fibers such as cotton or any synthetic fiber such as nylon, polyester, rubber polymer; OR any material described above in tube layers measuring in width from a minimum of ½″ to a maximum of 78.5″ wide and measuring in thickness of 2 mm or less to a micron and in the case of textiles from 100 oz. sq. yd or less.

The polyimide film can be utilized as a tube or carcass or cover layer. The polyimide film would preferably be used in addition to the other layers as an additional layer in the tube, carcass and/or cover. As such, the polyimide layer could be used in one or more of the layers or in none of the layers. The use of the polyimide film serves as both a gas barrier as well as a thermal barrier. The polyimide is a film, rather than a textile, and is applied in either a cigar wrap with longitudinal seam or spiral wrap, or in tube form. The polyimide film reduces the leakage of permeation of the exhaust gas when used in combination with the all glass textile, which is porous. The polyimide film has good thermal resistance properties over 400° C. and good mechanical properties including resistance to vibration. The use of the polyimide film layer is dependant on the application. If the temperature requirement called for an increased thermal protection, then the polyimide film layer could be used.

The above cover layer(s) 17 may be applied in a spiral wound fashion in either of one direction and angle or opposing directions or angles with an overlap of zero inches to 2″ inches. Alternatively the cover layer(s) 17 may be applied longitudinally down the length of the mandrel over inner profile wire (see layer 1) and over tube layer (see layer 2) and over carcass layer(s) if present (see layer 3) in a wrapped fashion with a longitudinal abutting seam or overlapping seam of zero to the circumference of the mandrel diameter with clearance of first layers effectively becoming two layers (plies).

The a cover layer(s) 17 may be applied singly or in any combination producing a total hose wall thickness in combination with the other tube layers 21 and 23, carcass of a minimum of 1/16″ to a maximum of 1″ thick or more.

An outer wire profile 16, 18 and 20 (preferred but optional). The outer wire profile is a metal or non-metal (steel, aluminum, plastic or composite) wire profile spiraled onto a cylindrical mandrel (rigid pipe) in a helical coil fashion. Said profile may be either round, flat, concave, oval or other profile in shape. See for example FIGS. 1-3. The profile has outside dimensions of a minimum of 0.025″ to 0.375″ in size. Wire may be spiraled with a spacing of zero inches to 2″ wide between the next spiral (commonly known as wire pitch) and wound in either one direction or opposite direction to the start position, to be spiraled perpendicular to the mandrel or at an angle of 30 degrees or more. The outer wire may be spiraled on between spacing (pitch) of inner wire or in the case of inner wire having zero space between spirals, the outer wire profile may sit in the apex or middle of the inner wire abutted edges. The outer wire provides external hoop strength and axial strength in compressing layer(s) between inner and outer wire to prevent movement, displacement of inner layers and provide finished round shape of hose.

Accordingly, the present invention provides a novel high-temperature composite hose that allows for the carrying of high temperature air, gases and liquids in a range of 600 to 2000° F. The hose remains flexible at such elevated temperatures and may be used in situations where solid or flexible metal hose was previously used.

Modifications and substitutions by one of ordinary skill in the art are considered to be within the scope of the present invention, which is not to be limited except by the allowed claims and their legal equivalents.

What is claimed is:

1. A high temperature composite hose comprising:
an inner wire element wound in a spiral fashion and having a predetermined spacing;
one or more inner layers applied over the inner wire element;
a cover layer applied over the one or more inner layers; and
an outer wire element applied over the cover layer, wherein the outer wire is applied in a spiral fashion and wherein the outer wire is configured to be placed in between the predetermined spacing of the inner wire element.

2. The hose of claim 1, wherein the inner wire element is selected from the group consisting of standard circular wire, flattened wire, or semicircular wire.

3. The hose of claim 1, wherein the inner wire element is constructed from a material selected from the group consisting of steel, aluminum, plastic and composite material.

4. The hose of claim 1, wherein the inner wire element features a profile that is selected from the group consisting of round, flat, concave and oval.

5. The hose of claim 1, wherein the predetermined spacing of the inner wire element is between 0 to 2 inches.

6. The hose of claim 1, wherein the one or more inner layers are applied in a spirally wound fashion.

7. The hose of claim 6, wherein the one or more inner layers are applied in one or more application methods selected from the group consisting of: spirally applied in one direction, spirally applied in opposing directions, longitudinally applied down a length of the hose, and in any combination of these application methods.

8. The Hose of claim 7, wherein an application of two or more layers includes an overlap of a second layer over a first layer.

9. The hose of claim 1, wherein the one or more inner layers are selected from the group consisting of: glass reinforced fabric, glass reinforced textile, ceramic cloth, fabric woven of metals, fabric woven of metal filaments, fabric braided of metal, fabric braided of metal filaments, glass woven textile, ceramic woven textile, glass or ceramic woven textile reinforced with metal or metal filaments, film and metal foils.

10. The hose of claim 1, wherein the one or more inner layers include a para-aramid synthetic fiber fabric or textile.

11. The hose of claim 1, wherein the one or more inner layers include a functional temperature resistance to exhaust, gaseous media and air at elevated temperatures from 500° F. to 2000° F.

12. The hose of claim 1, wherein the one or more inner layers include at least a first inner layer proximate said inner wire element and a second layer proximate said first inner layer, wherein the second layer is selected from the group consisting of a para-aramid synthetic fiber or textile, a para-aramid coated textile, a fabric woven or braided of metals or metal filaments, a textile or cloth made of natural fibers, silicone rubber, silicone coated textile, films made of polytetrofluoro ethylene, textiles coated with polytetrofluoro ethylene based material, nylon film, nylon coated textiles, metal foils, fluoro elastomer coated textiles, ethylene propylene diene monomer coated textiles, flame retardant thermoplastic rubber and non-flame retardant thermoplastic rubber.

13. The hose of claim 1, wherein the cover layer provides one or more properties selected from the group of properties consisting of: UV resistance, ozone resistance, abrasion resistance, scuff resistance, liquid resistance and chemical resistance.

14. The hose of claim 1, wherein the cover layer is constructed from a material selected from the group consisting of: a plastic film, a thermoplastic film, a composite, a polyimide film, a coated fabric or textile cloth made of natural fibers such as cotton, an uncoated fabric or textile cloth made of natural fibers such as cotton, and a synthetic fiber selected from the group consisting of nylon, polyester and rubber polymer.

15. The hose of claim 1, wherein the cover layer is applied in a manner selected from the group of methods consisting of spiral wound in one direction and angle, spiral wound in opposing directions and angles and longitudinally.

16. The hose of claim 1, further comprising:
one or more carcass layers disposed between the one or more inner layers and the cover layer, wherein the one or more carcass layers are configured to provide material strength both axially and longitudinally and to serve as a filler and an insulator, wherein the one or more carcass layers are constructed from a material selected from the group consisting of: a plastic film, a thermoplastic film, a polyimide film, a fabric or textile cloth coated or uncoated made of natural fibers such as cotton, and a synthetic fiber selected from the group consisting of nylon, polyester, and rubber polymer.

17. The hose of claim 16, wherein the one or more carcass layers are applied in a manner selected from the group of methods consisting of spiral wound in one direction and angle, spiral wound in opposing directions and angles and longitudinally.

18. The hose of claim 1, wherein at least one of the inner or cover layers of the hose includes a polyimide film, wherein the polyimide film is configured to serve as both a gas barrier as well as a thermal barrier.

19. A method of forming a high temperature composite hose comprising the acts of:
forming an inner wire element wound in a spiral fashion;
applying one or more inner layers of fabric and/or textile over the wound inner wire element, wherein at least a first inner layer adjacent said inner wire element includes a heat resistant material;
applying a cover layer over the one or more inner layers of fabric and/or textile; and
wrapping an outer wire element over the cover layer, wherein the outer wire is applied in a spiral fashion and wherein the outer wire is configured to be placed in between a spacing of the inner wire element, wherein the outer wire element is configured to provide axial and hoop strength as well as compression strength.
